(19) United States
(12) Patent Application Publication
(10) Pub. No.: US 2007/0206474 A1
(43) Pub. Date: Sep. 6, 2007

(54) Information recording and reproducing apparatus, and information recording method

(76) Inventors: Masaharu Kondou, Kokubunji (JP); Takeshi Maeda, Koganei (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/477,633

(22) Filed: Jun. 30, 2006

(30) Foreign Application Priority Data
Mar. 1, 2006 (JP) 2006-055108

(51) Int. Cl. G11B 7/0045

(52) U.S. Cl. 369/59.11

(57) ABSTRACT

Interlayer crosstalk from a layer (non-readout layer) other than a readout layer, which poses a problem for a next-generation multi-layer optical disk, is reduced. A plurality (t) of tables showing a correspondence between user data and combinations of length, position, and total area of one or a plurality of marks in the user data are used. The possible range of the total mark area is varied depending on the tables. The tables containing user data and combinations of the length, position, and total area of the marks are switched by determining between what values in a number (t-l) of combinations of thresholds of mark areas the total area value of the marks contained in the predetermined number of past data cells (m) falls. The amount of disturbance in mark area is reduced by restricting the range of the area of a subsequent mark that is to appear.

### CLAIM OF PRIORITY

The present application claims priority form Japanese application JP 2006-055108 filed on Mar. 1, 2006, the content of which is hereby incorporated by reference into this application.

### BACKGROUND OF THE INVENTION

1. Field of the Invention

The present invention relates to a method and apparatus for recording and reproducing information on a medium, using changes in optical characteristics. Particularly, it relates to an optical disk apparatus.

2. Background Art

As a method for increasing the areal density of an optical disk, Non-patent Document 1 proposes a SCIPER (Single Carrier Independent Pit Edge Recording) method by which marks are recorded on a disk surface at equal intervals, front- and rear-edge positions are independently-varied, their positional changes are observed in the form of changes in multi-levels at specific detecting points, and information is read.

Referring to FIG. 1, the principle of the SCIPER method according to the conventional art will be described. Groups of prepits 102 to 107 are formed along a track center 101 on the disk surface in advance. Each group includes a pair of prepits 103 and 104 or a pair of prepits 105 and 106, each prepit being asymmetrically disposed on either side of the track center 101 for detecting a track signal. It also includes prepits 102 and 107 disposed on the track center for providing a clock. A data recording area, or a data block, is disposed between the groups of prepits. The data block is further divided into a plurality of data cells 108 with a length P. Each data cell contains a mark 110, 111, or 112. The front- and rear-edge positions of each mark are modulated from a specific center position by distances which are integer multiples of a specific interval A, such that their edge positions represent information.

A minimum mark length Lmin of a mark formed is selected such that, when reading the recorded information by means of a reading spot 109, a readout signal picked up from the front edge is not influenced by the rear edge, i.e., such that there is no interference between the front and rear edges. A maximum mark length Lmax is selected such that the gap between the maximum-length mark in a data cell and the maximum-length mark in an adjacent data cell is equal to the minimum mark length Lmin, so that the signals from the front and rear or the rear and front edges of the two marks do not interfere with each other. User data is associated with the number (n+l)x(n+l) of combinations of edge positions, where n is the number of divisions of the position that each of front and rear edges can take in units of interval A. In order to increase the areal density, the number n of divisions in units of interval A has to be increased.

FIG. 2 illustrates how the information stored at the front- and rear-edges of a mark is read. When the edge positions are not shifted, that is during non-modulation, the mark has its front edge positioned at 201 and rear edge at 202, with a mark length Lo. The front edge position is varied independently based on its center at position 201 by an integer multiple of an interval A, and so is the rear edge position, based on its center at position 202. As a result, the mark length varies between the minimum mark length Lmin and the maximum mark length Lmax. When reading the information stored at the edge positions, a shift value in the edge positions is detected by observing a readout signal waveform at timings corresponding to both edges of the mark. Specifically, the levels of a readout signal 409 are measured at timings of the edges 201 and 202 of non-modulated data, so that the front- and rear-edge positions can be detected by converting them into multi-levels.

Patent Document 1 discloses a method for achieving higher density than the SCIPER method by making a minimum mark position variable. Referring to FIG. 3, a method disclosed in Patent Document 1 will be disclosed. A track is divided into data cells at equal intervals, and the inside of the data cells is further divided at specific intervals A. A single mark is disposed inside the data cell, and the front- and rear-edges of the mark are positioned at the front and rear portion of the divided position, respectively. It is noted that the minimum distance between the front and rear edges, i.e., the minimum mark length, is Lmin so that there is no interference between the edges. The number of combinations of edge positions is (2n+l)+2n++1=(n+l)x(2n+1), where n is the number of divisions of the position that each of front and rear edges can take in units of interval A. Namely, user data is associated with the number of combinations of edge positions (n+l)x(2n+1).

Non-patent Document 1: Japan Journal of Applied Physics, Vol. 35, pp. 437-442, 1996

Patent Document 1: JP Patent Publication (Kokai) No. 2004-039117 A

### SUMMARY OF THE INVENTION

With regard to a next-generation multi-layer optical disk, one of the major problems associated with its multilayer structure is that readout signals deteriorate due to interlayer crosstalk from a layer (non-readout layer) other than the readout layer. One of the factors for causing such interlayer crosstalk is an influence from a recorded mark on the non-readout layer. This influence varies depending on the length or distribution of the mark on the non-readout layer, the distance between the readout layer and the non-readout layer, the recording state (recorded or not recorded) of the non-readout layer, the eccentricity of the track, or the like. Since the mark portion has higher reflectivity and lower transmittance than the non-marked portion, the disturbance in mark distribution on the non-readout layer becomes present as a signal disturbance due to the disturbance in the amount of light reflected from the non-readout layer or as a signal disturbance due to the disturbance in the amount of light transmitted through the non-readout layer during reading. With regard to the disturbance in the amount of light reflected from the non-readout layer, since an optical spot from the readout layer and an optical spot from the non-readout layer have different intensity profiles on a detector, the disturbance can be reduced by employing confocal optics or adjusting the detector size, for example. However, with regard to the disturbance in the amount of light transmitted through the non-readout layer, since the optical spot from the readout layer is influenced by the signal disturbance, it is impossible to remove the disturbance optically. Thus, it is necessary to reduce the amount of signal disturbance, i.e., the amount of disturbance in the mark area.

Patent Document 1 uses a table that represents a correspondence between user data and a pair of front and rear edges of a single mark contained in the user data. However, the present invention uses a plurality (“t”) of tables that represent a correspondence between user data and combinations of the length, position, and total area of one or a plurality of marks contained in the user data. The possible range of total area of the mark is varied depending on the table. The tables containing user data and the combinations of the length, position, and total area of the marks are switched by determining between what values the total area value of the marks contained in a predetermined number (“m”) of past data cells falls among a number (t-1) of combinations of thresholds of mark areas. This is intended to restrict the range of the area of a subsequent mark that appears by evaluating not only user data but also the total area value of marks contained in the past m referred data cells. For example, by using a table such that a minimum mark does not appear when all marks in the past m referred data cells are minimum marks, the overall mark area is adjusted so that it does not become too small. The amount of disturbance in mark area can be reduced by searching the t tables, which represent a correspondence between user data and combinations of the length, position, and total area of marks, for a combination of the number m of the past data cells referred to and the number (t-1) of thresholds of mark areas that minimizes the ratio of the maximum to the minimum value of the average of the mark areas in a sufficiently long data cell sequence.

An information recording apparatus according to the present invention records data by forming one or a plurality of marks in a plurality of data cells provided along a track on a disk-type recording medium. The apparatus includes a light source, optics for forming a small spot on the surface of the recording medium by converging light flux emitted from the light source, an encoder for converting user data into a combination of front-and rear-edge positions of a mark formed in the data cell, a modulator for generating a write waveform based on front- and rear-edge position information outputted from the encoder, and a light source driving unit for driving the light source in accordance with the write waveform outputted from the modulator. The encoder has a means for generating a pulse signal that rises at the front-edge position and falls at the rear-edge position with a clock signal, which is generated at such timings that the data cell is divided into a predetermined number of areas at equal intervals in the direction of the track in accordance with the rotation of the disk-type recording medium, and a means for generating the write waveform based on the pulse signal. The encoder further includes a plurality of converting tables and switches the tables for use in accordance with a mark area contained in a predetermined number (m) of most recent data cells.

An information reproducing apparatus according to the invention reproduces information by detecting one of a plurality of marks formed in a plurality of data cells provided along a track on a disk-type recording medium. The apparatus includes optics for irradiating the disk-type recording medium with an optical spot, a photodetector for detecting light reflected by the disk-type recording medium, a mark detecting unit for detecting the length and position of a mark in the data cell by processing a readout signal outputted from the photodetector, and a decoder for converting the combination of length and position of the mark into user data. The mark detecting unit may include a data cell signal generating circuit for generating a data cell signal indicating the start point of each data cell, a sample signal generating circuit for generating a sample signal at predetermined multiple timings based on the data cell signal, a memory circuit for storing the readout signal sampled by the sample signal, and a front- and rear-edge detecting circuit for detecting a sampling point as a front-edge position, at which a readout signal is closest to a predetermined level in a phase of the readout signal, which is stored in the memory circuit, increasing with time, and detecting another sampling point as a rear-edge position, at which a readout signal is closest to a predetermined level in a phase of the readout signal, which is stored in the memory circuit, decreasing with time. Preferably, the sample signal generating circuit generates the sample signal at such timings that the data cell is divided into a predetermined number of areas at intervals of edge position variation of the mark in the direction of the track. The predetermined level may be equal to the half-value level of the readout signal. The mark detecting circuit may include a means for detecting the peak position of the readout signal with a differential circuit and a comparator, and a means for sample-holding the signal level of the peak position. The center position of the mark can be obtained based on the peak position of the readout signal while the length of the mark can be obtained based on the signal level of the peak position. The decoder converts mark information, comprised of a combination of front- and rear-edge positions of the mark, or mark information, comprised of the center position and length of the mark in the data cell, into user data via a converting table. With regard to the converting table, while each item of mark information corresponds to user data, some specific user data correspond to a plurality of items of mark information. For example, user data may correspond to mark information regarding a minimum mark area and also mark information regarding a maximum mark area in the converting table.

In accordance with the present invention, disturbance in the amount of light transmitted through the non-readout layer, which cannot be optically removed, can be reduced.

### BRIEF DESCRIPTION OF THE DRAWINGS

FIG. 1 illustrates the principle of a conventional SCIPER method.

FIG. 2 illustrates the reading of information stored at the front- and rear-edge positions of a mark.

FIG. 3 illustrates the number of items of information that can be expressed by combinations of mark length and edge positions.

FIG. 4 is a diagram of an optical information recording and reproducing apparatus according to the invention when a data cell contains a single mark.

FIGS. 5A to 5K show a timing chart for the invention.

FIG. 6 shows a block diagram of an encoder when the data cell contains a single mark.

FIG. 7 shows a table for converting user data into front- and rear-edge positions or an NRZI codeword.

FIG. 8 shows a table for converting user data into front- and rear-edge positions or an NRZI codeword.

FIG. 9 shows a block diagram of a modulator when the data cell contains a single mark.

FIG. 10 shows a block diagram of a data detector when the data cell contains a single mark.

FIG. 11 shows a flowchart of the processes performed in the data detector when the data cell contains a single mark.

FIG. 12 shows a block diagram of a decoder when the data cell contains a single mark.

FIG. 13 shows a block diagram of another example of the data detector when the data cell contains a single mark.

FIG. 14 shows a flowchart of the processes performed by a decision circuit provided in the data detector when the data cell contains a single mark.

FIG. 15 shows a flowchart of the processes performed by a decision circuit provided in the data detector when the data cell contains a single mark.

FIG. 16 shows a sequence such that the mark area becomes minimum in modulation code 17PP (1 to 7 Parity Preserved).

FIG. 17 shows a sequence such that the mark area becomes maximum in modulation code 17PP.

FIG. 18 shows a sequence such that the mark area becomes minimum in the invention.

FIG. 19 shows a sequence such that the mark area becomes maximum in the invention.

FIG. 20 shows a graph of a power spectrum in modulation code 17PP.

FIG. 21 shows a graph of a power spectrum in the invention.

FIG. 22 shows a block diagram of an optical information recording and reproducing apparatus according to the invention when the data cell contains one or a plurality of marks.

FIG. 23 shows a block diagram of an example of an encoder when the data cell contains one or a plurality of marks.

FIG. 24 shows a block diagram of an example of a modulator when the data cell contains one or a plurality of marks.

FIG. 25 shows a block diagram of an example of a decoder when the data cell contains one mark.

FIG. 26 shows a table for converting user data into a NRZI codeword when detecting a mark center position and a mark length.

FIG. 27 shows another table for converting user data into a NRZI codeword when detecting a mark center position and a mark length.

FIG. 28 shows a block diagram of an example of a data detector when the data cell contains one or a plurality of marks.

FIG. 29 shows a diagram in which peak positions of readout signals and sample-held signal levels at the peak positions are represented as points that are superimposed at intervals of data cells.

FIG. 30 shows a table for converting user data into a NRZI codeword when a converting table switches three tables and the data cell contains two marks.

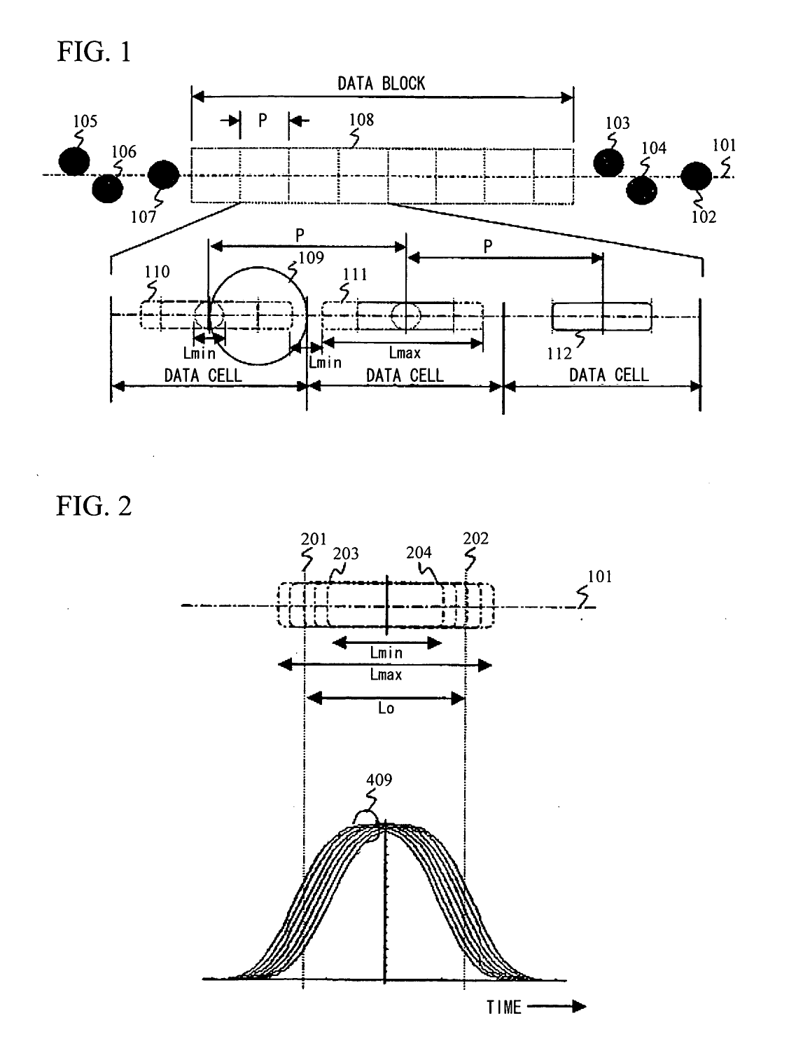

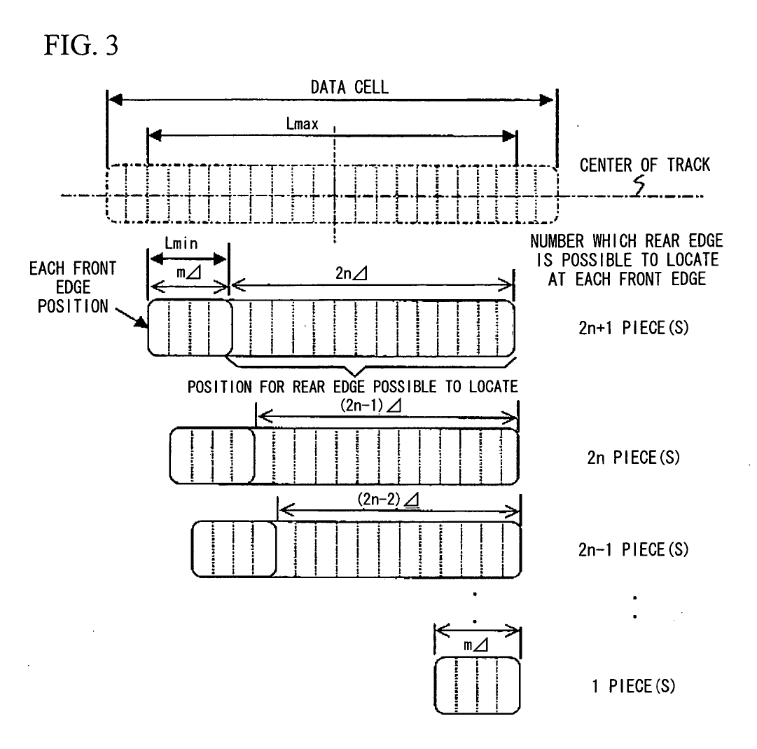

### DESCRIPTION OF PREFERRED EMBODIMENTS OF THE INVENTION

The present invention will be hereafter described by way of embodiments with reference made to the attached drawings, in which like reference numerals identify similar functional elements.

[Embodiment 1]

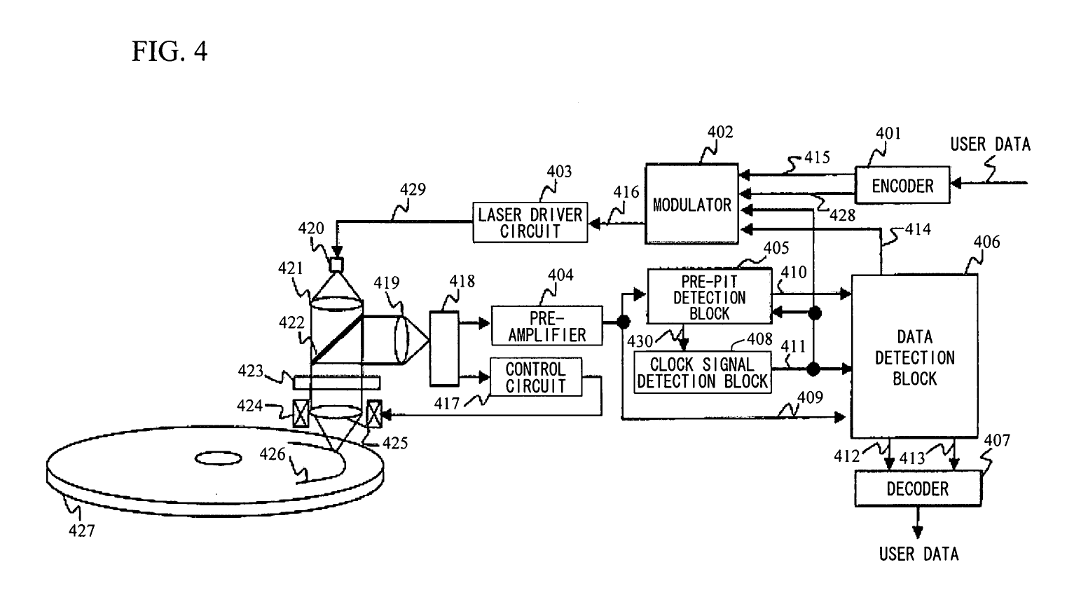

A first embodiment of the invention will be described by referring to FIGS. 4 to 12.

FIG. 4 shows a block diagram of an optical information recording and reproducing apparatus according to the invention, in a case where a data cell has one mark. Light emitted by a semiconductor laser 420 is collimated into parallel light by a collimator lens 421. The parallel light passes through a polarized beam splitter 422 and further through a 1/4-wavelength plate 423, whereby the linear polarized light is converted into circular polarized light. The circular polarized light is focused on a rotating disk-type recording medium 427 by an object lens 425, forming a small spot thereon. Light reflected by the recording medium 427 passes through the object lens 425 again and further through the 1/4-wavelength plate 423, whereby the light is converted into linear polarized light with its direction of polarization rotated by 90 degrees with respect to the incident light. The linear polarized light has its optical path bent by the polarized beam splitter 422 and is thereafter converged by a lens 419 onto a photodetector 418. The optical path is separated by optical functional devices (not shown) in the photodetector 418. The reflected light is therefore guided to a detector for generating an error signal which is used in positioning of the light spot, tracking and focusing, for example, and to another detector for generating a readout signal for detecting data. Based on the error signal, a control circuit 417 generates, in a conventional manner, a control signal for tracking and focusing, by which a two-dimensional actuator 424 is driven such that the light spot is positioned in an optimal state for recording and reading.

In the detector which generates the readout signal, the reflected beam of light passing through the objective lens 425 is received and photoelectrically converted into an electric signal by the photodetector. After amplification in a pre-amplifier 404, the photoelectrically converted readout signal is sent to a prepit detection block 405 for detecting groups of prepits that are provided on a track 426 on the recording medium in advance, to a clock signal detection block 408 for detecting a clock signal from clock pits provided on the track in advance, and to a data detector 406. An edge position signal detected by the data detector 406 is decoded by a decoder 407 and outputted as user data.

When user data is recorded, it is first inputted to an encoder 401 where the data is converted into information regarding front- and rear-edge positions. Items of information 415 and 428 regarding front- and rear-edge positions are inputted to a modulator 402 to which a data cell signal 414 and a clock detection signal 411 are also inputted. The modulator 402 creates a modulated pulse 416 corresponding to a mark to be recorded in a data cell on a track, thus converting the user data into a waveform that is actually recorded. The waveform 416 is inputted to a laser driver circuit 403 by which the laser light source is current-modulated, so that the light intensity of the semiconductor laser 420 can be varied.

On the disc surface, the position of the light spot is controlled to follow a track center 101 such that marks are formed in data cells. Each mark consists of a marked portion and a non-marked portion having different optical characteristics. A minimum mark length Lmin of the formed mark is selected such that when the mark is read by the reading spot 109, a readout signal from the front edge is not influenced by the rear edge, namely, there is no interference from the rear edge. The shortest distance between two marks formed in adjacent data cells is also set at Lmin.

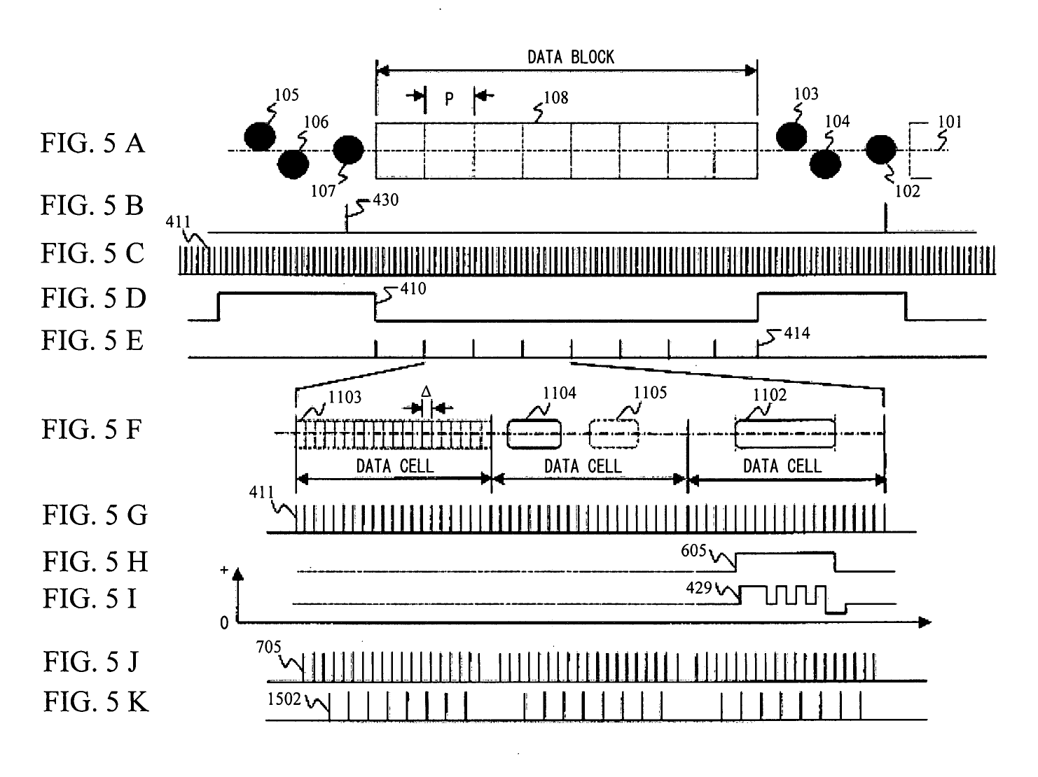

Referring to the timing chart of FIGS. 5A, to 5K the operation of the apparatus at its individual portions will be described. FIG. 5A shows the positional relationship among groups of prepits 102, 103, 104, 105,. 106, and 107, a data block, and data cells 108 (enclosed by dotted line) provided in the block, on the disk surface. FIG. 5B, corresponding to FIG. 5A, shows a clock pit signal 430 created from the clock pits 102 and 107 in the groups of prepits. The clock pit signal 430 may be detected in a conventional manner using a sample servo technique. FIG. 5C shows a clock signal 411 created from the clock pit signal 430. For this, a conventional PLL (phase-locked loop) may be used. FIG. SD shows a prepit signal 410 indicating the groups of prepits. The prepit signal 410 is created by using the clock signal 411 and the readout signal 409.

FIG. 5E shows the timing of a data cell signal 414 created from the prepit signal 410 and clock signal 411. The data cell signal 414 indicates break points of data cells. FIG. SF illustrates the position of marks in three data cells. As the spot is transported over the disc surface at a constant velocity, the time axes of FIGS. SB, C, D and E are extended. An area 1103 indicated by dotted line in the first data cell indicates an area that a mark can occupy on a track at intervals A. Marks 1104 and 1105 in the second data cell indicate examples of the mark that can be recorded according to the invention. The mark 1104 indicates a case where a mark edge is positioned at the farthest edge of the data cell. The mark 1105 indicates a position that a conventional mark can take. The third data cell shows a mark 1102 recorded by a write waveform 429, which will be described later. In accordance with the invention, each data cell has one mark. FIG. 5G shows the clock signal 411 with an extended time axis.

FIG. 5H shows a modulated data waveform 605 corresponding to the mark 1102. FIG. 51 shows the write waveform 429, which is created from the modulated data waveform 605, for recording the mark 1102. FIG. 5J shows the timing of a sample clock 705 having a period corresponding to a specific interval A. The sample clock 705 is used for reading the marks in the data cells. FIG. 5K shows a sample pulse 1502 used in another embodiment of the invention. Hereafter, the operation of each block shown in FIG. 4 will be described in detail.

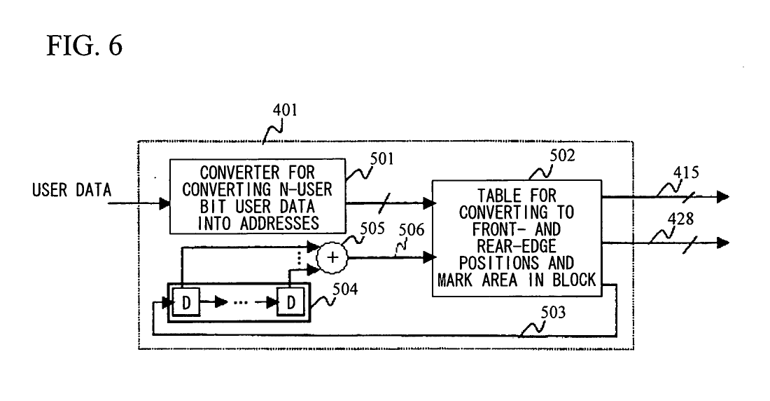

FIG. 6 shows a block diagram of an example of the encoder 401. The output of each shift register in the shift register circuit 504, which stores the sum of areas of the marks in the past m data cells, is inputted to the m-input adder 505. The adder 505 outputs a sum 506 of the mark areas in the m data cells. N-bit user data is converted by an address converter 501 into addresses for a converting table that will be described later. The addresses and the sum 506 of the mark areas are inputted to a table 502 where they are converted into front- and rear-edge positions and mark area in each data block. The table 502 thus outputs data 415, 428 and 503 for the front- and rear-edge positions and the mark area, respectively, of which the data 415 and 428 constitute the outputs of the encoder 401. The output 503 is inputted to the shift register circuit 504, and the individual shift register values in the shift register circuit 504 are updated.

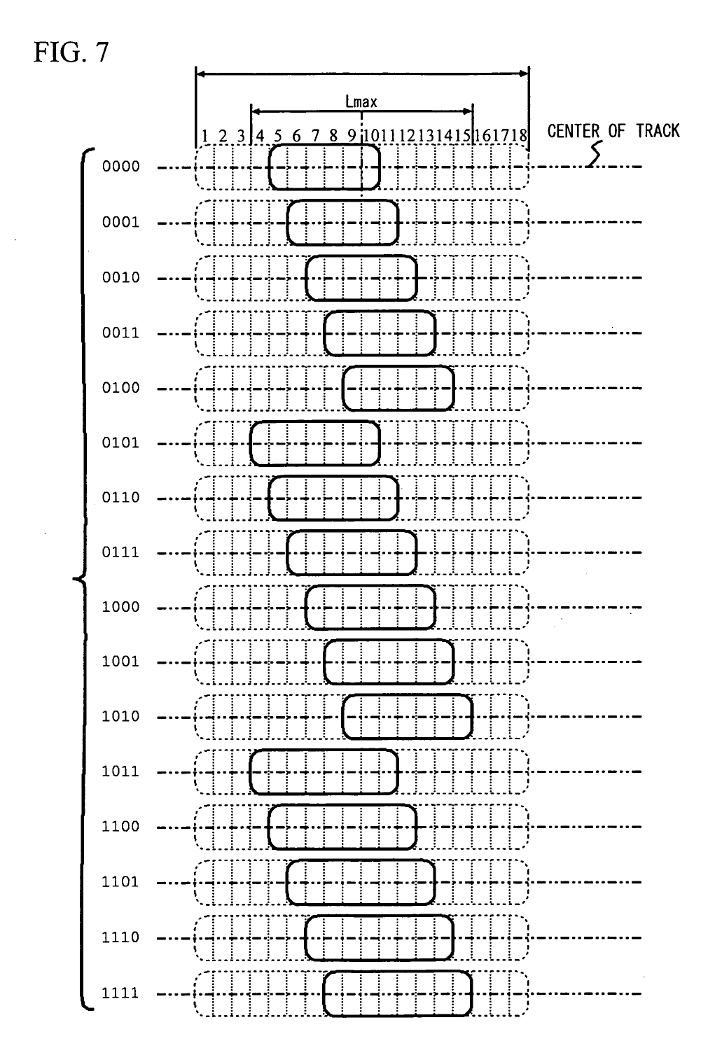

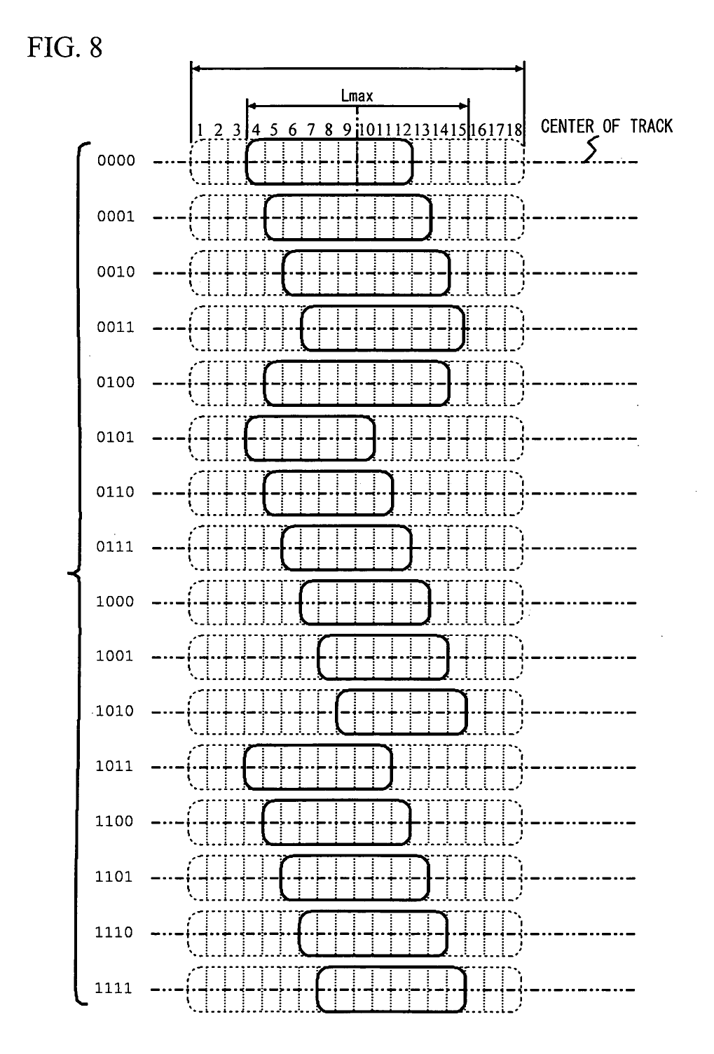

An example of the converting table 502 will be described by referring Tables I and 2 shown below and FIGS. 7 and 8. It is herein assumed that the mark area is proportional to the mark length and that the mark area is obtained by multiplying the mark length by a proportional constant w. In this example, user data is represented by four bits, which can represent 16 items of information. Thus, it is only necessary that combinations of mark lengths and mark positions corresponding to such number can be recorded. As the number n of possible positions of each of a front edge and a rear edge is varied, the number of combinations of the mark lengths and mark edges that can be represented varies. When n=l, the number Ti of possible combinations is six. When n=2, the number is 15. When n=3, the number is 28. Accordingly, in order to represent the 16 items of information represented by the four user bits, n must be three or more, and it is insufficient if n=l or 2. In the present example, n=3.

Supposing now that Lmin is 6 times the specific interval A, the length of a data cell P, which is (Lmin+Lmax), is 18 times the specific interval A. Thus, the data cell is divided into 18 regions at intervals A, and each region is given a number from 1 to 18, as shown in FIG. 7. Each user bit is associated with a combination of the number of a region where the front edge of the mark coincides with the front edge of the area, the number of a region where the rear edge of the mark coincides with the rear edge of the area, and the mark area as shown in Table 1. FIG. 7 and Table 1 show 16 items selected from data cells having mark areas from 6Aw to 8Aw. FIG. 8 and Table 2 show 16 items selected from data cells having mark areas from 7Aw to 10Aw. Now designating Tables 1 and 2 as first and second table, respectively, it is seen that the data cells in Tables I and 2 are selected so that the minimum mark area value 6Aw in the data cells represented by the codewords of the first table is smaller than the minimum mark area value (7Aw) in the data cells represented by the codewords of the second table, and that the maximum mark area value 8Aw in the data cells represented by the codewords of the first table is smaller than the minimum mark area value (10Aw) in the data cells represented by the codewords of the second table.

TABLE 1

| | Region number | | | | Region number | | |
|---|---|---|---|---|---|---|---|
| | Front | Rear | Mark | | Front | Rear | Mark |
| User bit | edge | edge | area | User bit | edge | edge | area |
| 0000 | 5 | 10 | 6Δw | 1000 | 7 | 13 | 7Δw |
| 0001 | 6 | 11 | 6Δw | 1001 | 8 | 14 | 7Δw |
| 0010 | 7 | 12 | 6Δw | 1010 | 9 | 15 | 7Δw |
| 0011 | 8 | 13 | 6Δw | 1011 | 4 | 11 | 8Δw |
| 0100 | 9 | 14 | 6Δw | 1100 | 5 | 12 | 8Δw |
| 0101 | 4 | 10 | 7Δw | 1101 | 6 | 13 | 8Δw |
| 0110 | 5 | 10 | 7Δw | 1110 | 7 | 14 | 8Δw |
| 0111 | 6 | 10 | 7Δw | 1111 | 8 | 15 | 8Δw |

TABLE 2

| | Region number | | | | Region number | | |
|---|---|---|---|---|---|---|---|
| | Front | Rear | Mark | | Front | Rear | Mark |
| User bit | edge | edge | area | User bit | edge | edge | area |
| 0000 | 4 | 12 | 9Δw | 1000 | 7 | 13 | 7Δw |
| 0001 | 5 | 13 | 9Δw | 1001 | 8 | 14 | 7Δw |
| 0010 | 6 | 14 | 9Δw | 1010 | 9 | 15 | 7Δw |
| 0011 | 7 | 15 | 9Δw | 1011 | 4 | 11 | 8Δw |
| 0100 | 5 | 14 | 10Δw | 1100 | 5 | 12 | 8Δw |
| 0101 | 4 | 10 | 7Δw | 1101 | 6 | 13 | 8Δw |
| 0110 | 5 | 10 | 7Δw | 1110 | 7 | 14 | 8Δw |
| 0111 | 6 | 10 | 7Δw | 1111 | 8 | 15 | 8Δw |

Since two tables, namely, Tables 1 and 2 are used (i.e., t=2), one threshold (t-10 of the mark area is necessary for switching tables. By designating Table 1 as a table used when the total mark area in the past two data cells is 15Aw or more and by designating Table 2 as a table used when the total mark area in the past two data cells does not reach 15Aw, the minimum and the maximum value of an average mark area value per data cell in a data cell sequence can be set to be 7Aw and 8Aw, respectively. This corresponds to the acquisition of (m, x)=(2, 15Aw) as a result of searching combinations of the number m of the past data cell referred to and the mark area threshold r for a combination such that the ratio of the maximum to the minimum values of an average mark area value in a data cell sequence can be minimized.

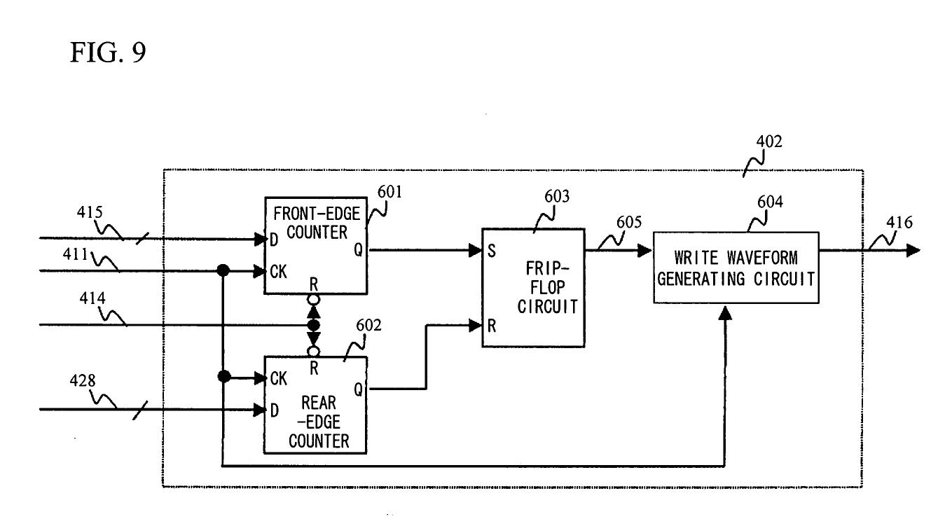

FIG. 9 shows a block diagram of an example of the modulator 402. Data 415 for the front-edge position and data 428 for the rear-edge position are supplied to a data terminal D of a front-edge counter 601 and a rear-edge counter 602, respectively. The counters count down in accordance with a clock 411, which is synchronized with the interval A, and output an output pulse from respective output terminal Q when they count down to zero. The counters are reset by a data cell signal 414, which is generated at the break points of the data cells. The output of the front-edge counter 601 is supplied to a set terminal S of a flip-flop circuit 603, while the output of the rear-edge counter 602 is inputted to a reset terminal R of the flip-flop circuit 603. An output signal 605 from the flip-flop circuit 603 is a pulse signal, which rises at the front-edge position and falls at the rear-edge position. It is known that if this waveform is recorded on an optical disk as is, the marks that are formed would have a teardrop shape. Various techniques are known to solve this problem, for example by converting the pulse into multiple pulses or into multiple levels. In the present embodiment of the invention, the pulse signal is converted by a write waveform generating circuit 604 into a waveform 416 that is actually recorded.

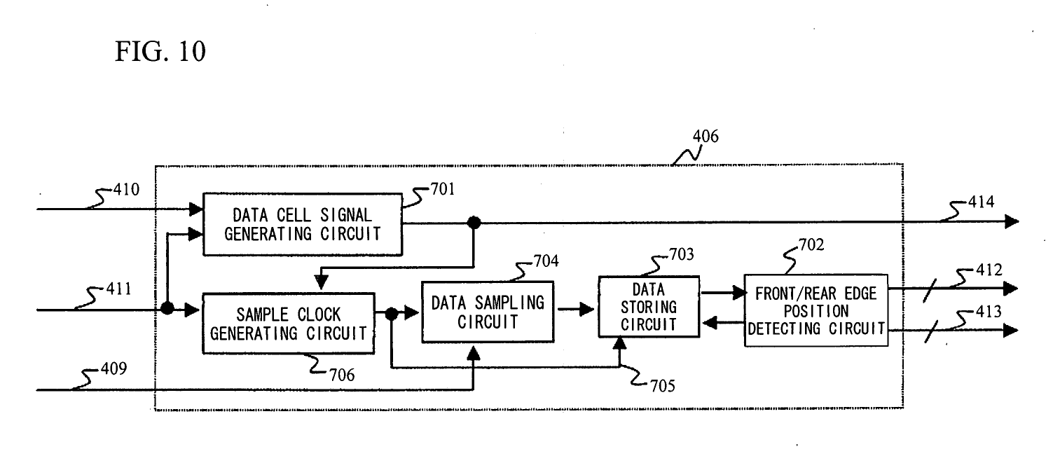

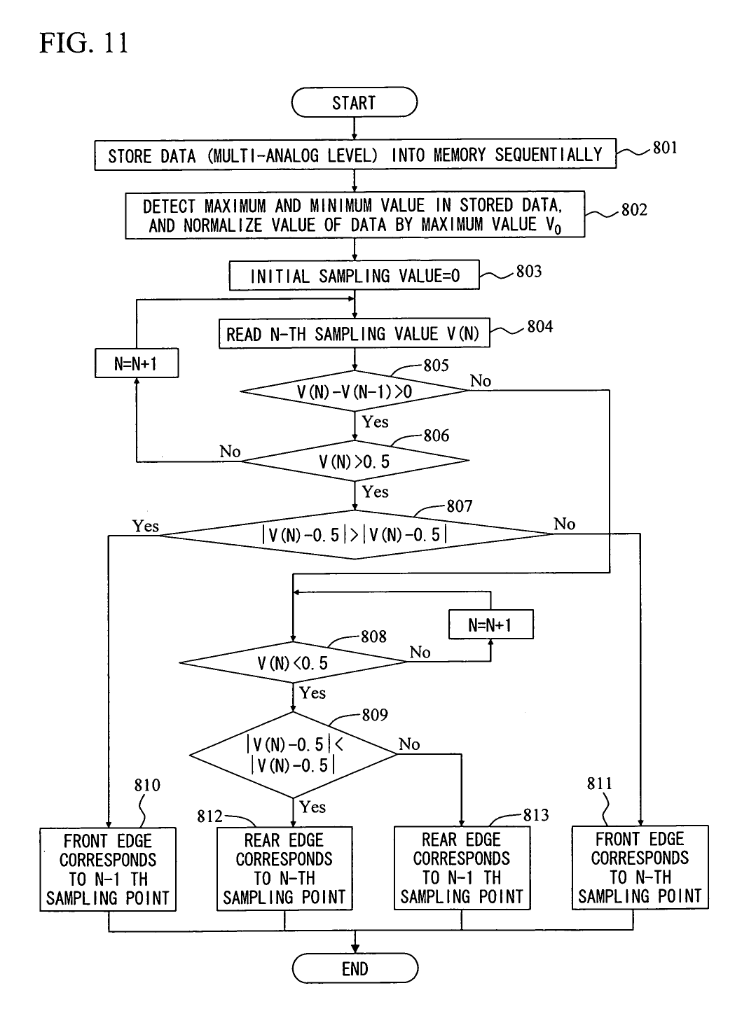

FIG. 10 shows a block diagram of an example of the data detector 406. The data cell signal 414, which indicates break points in the data cells, is generated in a data cell signal generating circuit 701 based on the prepit signal 410, which indicates the interval in which a group of prepits exists, and the clock signal 411. The data cell signal 414 and clock signal 411 are supplied to a sample clock generating circuit 706 which creates a sample clock 705 corresponding to the specific intervals A. The readout signal 409 is sampled by the sample clock 705 in a data sampling circuit 704. Sampled values are stored in a data storing circuit 703 in accordance with the sample clock 705. The stored sampled data is read by a front/rear edge position detecting circuit 702. The front- and rear-edge positions can be determined through a process in the front/rear edge position detecting circuit 702. In the present embodiment, the edge is detected by taking advantage of the fact that, since there is no interference, the mark position and the timing of a half-value level of a detected signal amplitude normalized by the maximum value Vo thereof correspond to the edge position.

FIG. 11 shows a flow chart of the process performed in the data detector 406. The process starts when the data cell signal 414 is inputted from the data cell signal generating circuit 701 to the sample clock generating circuit 706. In step 801, the data sampling circuit 704 samples the readout signal 409 of the data cell in synchronism with the sample clock 705 and sequentially stores a sampled signal in the data storing circuit 703. After storage is complete, the process goes to step 802 where the maximum and minimum values in the data cell are determined, a maximum amplitude Vo is detected, and the readout signal is normalized by using the value of Vo. In step 803, the initial value in the counters for counting sampling points is set to zero.

In step 804, a sample value V(N) of a number corresponding to the value N indicated by the counter is read. In step 805, the magnitude of the Nth sampling value V(N) is compared with that of an N-Ith sampling value V(N-1). If the N-ith sampling value is larger, this indicates that the waveform is falling, so the process goes to step 808. If the Nth sampling value is larger, this indicates that the waveform is rising, so the process goes to step 806, where it is determined whether the Nth sampling value exceeds the half-value level. If not, N is incremented and the process goes back to step 804 where the Nth signal is read. If the half-value level is exceeded, the process goes to step 807 to determine which of the Nth sampling value and the N-Ith sampling value is closer to the half-value level. If the N-lth sampling value V(N-1) is closer to the half-value, the process goes to step 810 to output a decision that the front-edge position is at the N-lth sampling point. If, on the other hand, the Nth sampling value V(N) is closer to the half-value, the process goes to step 811 and a decision is given that the front edge is positioned at the Nth sampling point.

In step 808, it is determined whether the falling signal has further dropped below the half-value. If not, N is incremented and step 808 is repeated. If the sampling value V(N) is below the half-value, the process goes to step 809. In step 809, it is determined which of the Nth sampling value V(N) and the N-lth sampling value V(N-I) is closer to the half-value, and the rear-edge position is judged to be located at the sampling point of the value closer to the half-value. Namely, if the Nth sampling value is closer to the half-value, the process goes to step 812 and a decision is given that the rear-edge is positioned at the Nth sampling position. If the N-I th sampling value is closer to the half-value, the process goes to step 813 to give a decision that the rear edge is positioned at the N-1th sampling point.

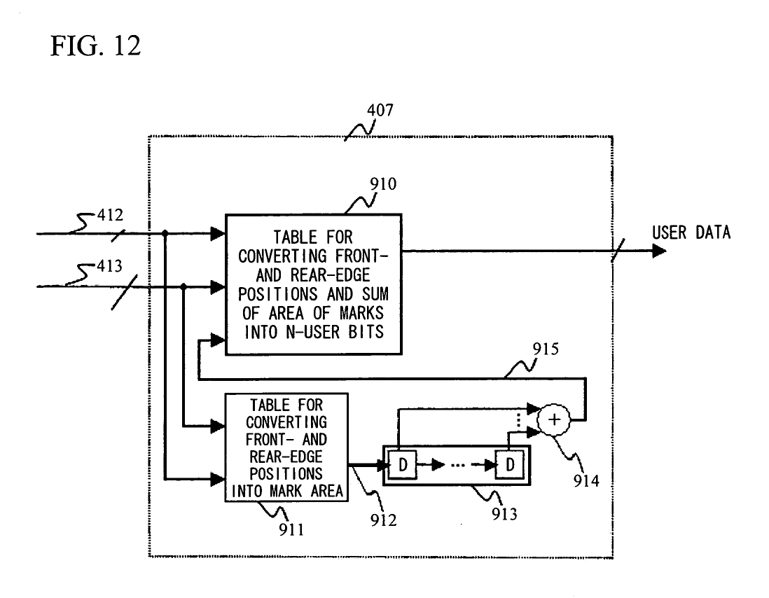

The detected front-edge position data 412 and rear-edge position data 413 are inputted to the decoder 407, whose example is shown in FIG. 12. The output of each shift resistor contained in a shift resistor circuit 913 for storing mark lengths for the past m data cells is inputted to an m-input adder 914 and a sum 915 of mark areas in m data cells is outputted. The edge position data is inputted to a table 910 that converts the front-edge position data 412, the rear-edge position data 413, and the sum 915 of mark areas into N user bits and that outputs corresponding user data. The table 910 performs inverse conversion with respect to the foregoing Tables I and 2, and generally, it associates user data with the combinations of the front- and rear-edge positions and the sum of mark areas in the m data cells. It is noted, however, that since the user data corresponding to the codewords for area 7Aw and 8Aw that are present in both Tables I and 2 is the same, the sum of mark areas in the past m data cells is not necessary for the table for decoding Tables 1 and 2. Meanwhile, a mark area converting table 911 calculates the area of marks having the front-edge position data 412 and the rear-edge position data 413 and outputs a calculation result 912. The calculation result 912 is inputted to the shift resistor circuit 913, thereby updating each shift resistor value therein.

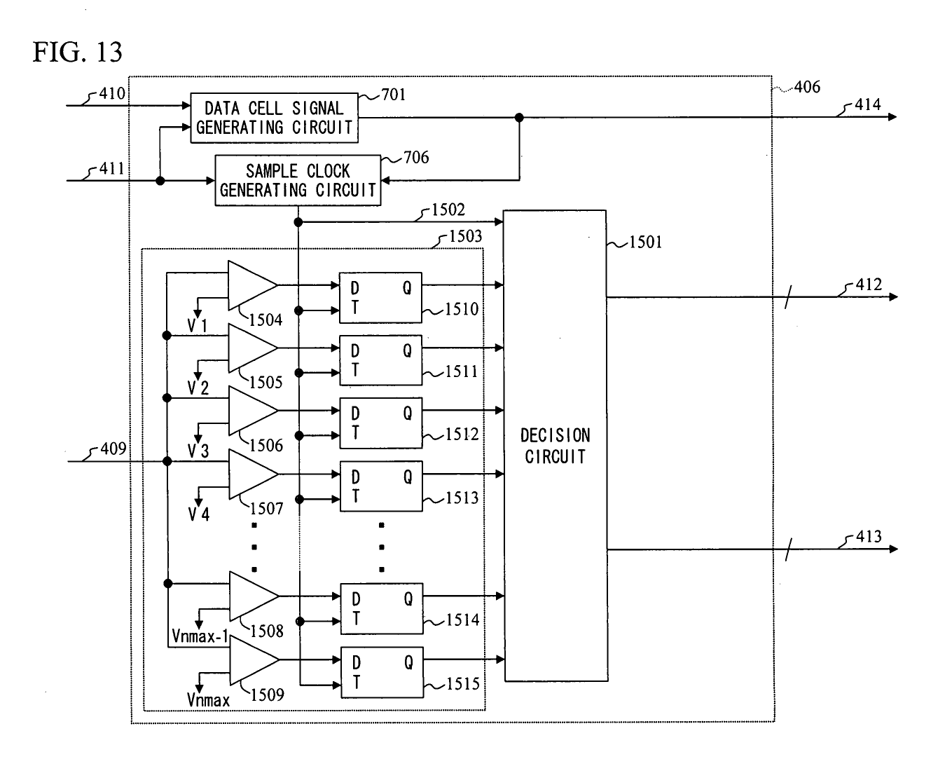

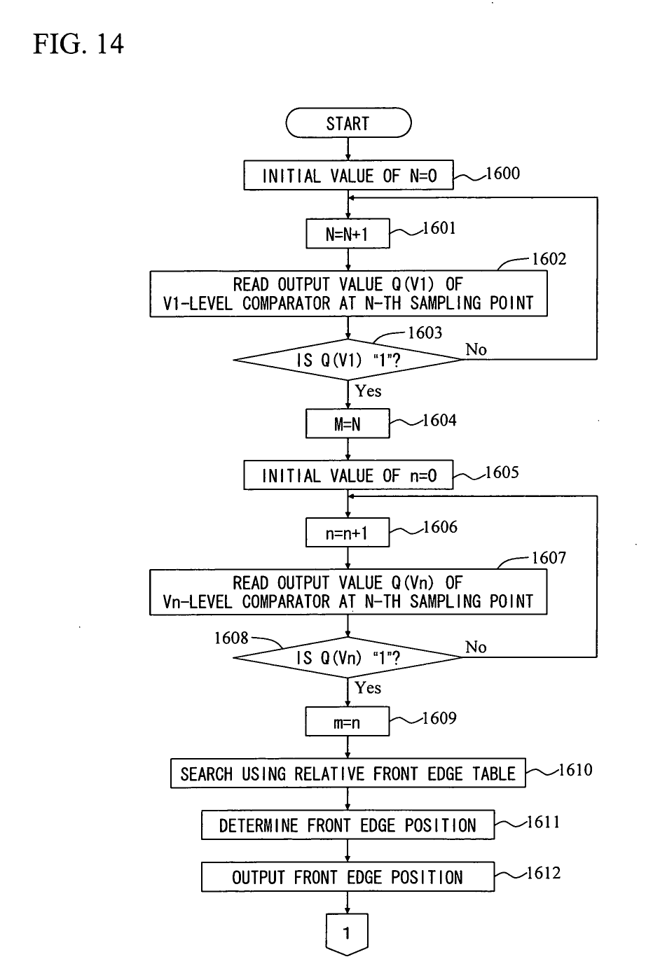

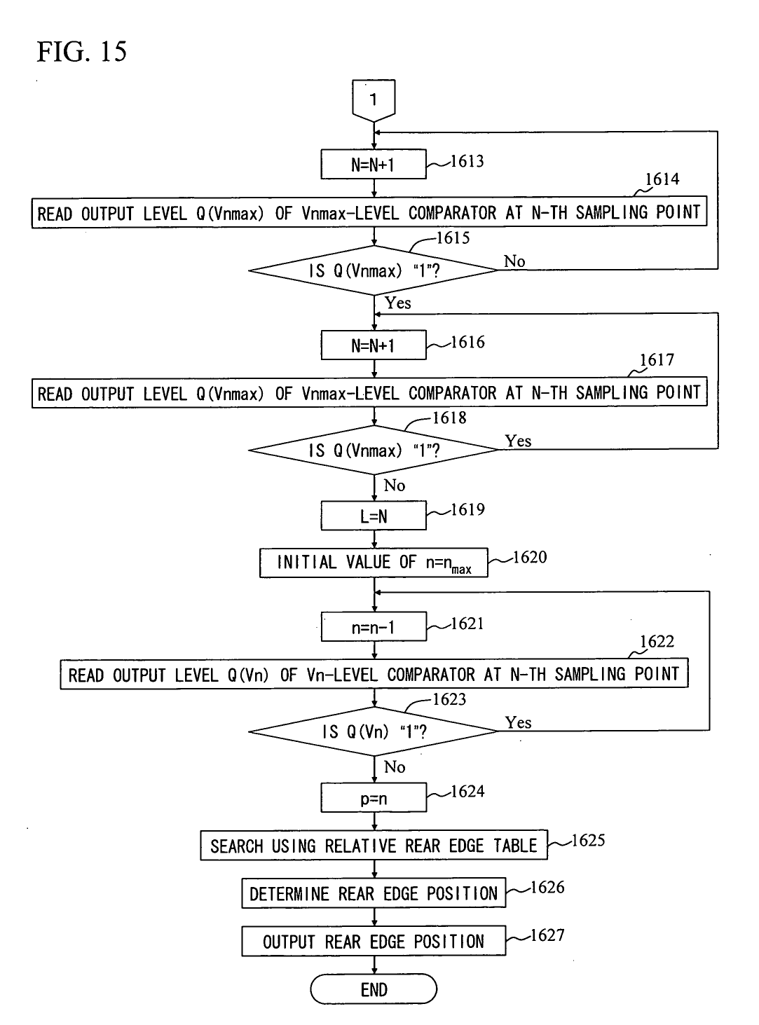

FIG. 13 shows a block diagram of the data detector 406 according to the present embodiment. FIGS. 14 and 15 show flow charts of the process performed in a decision circuit provided in the data detector 406.

The readout signal 409 is inputted to comparators 1504, 1505, 1506, 1507, 1508, and 1509 having different thresholds. The comparators compare the input level with their respective threshold voltages, and output “1” if the input level is larger than the threshold, and “0” below the threshold. The output of each comparator is supplied to a flip-flop circuit 1510, 1511, 1512, 1513, . . . , 1514, or 1515, and acquired by each flip-flop circuit at the timing of the sample pulse 1502 when the value is finalized. The output of each flip-flop circuit is coupled to a decision circuit 1501, where the process as shown in FIGS. 14 and 15 is performed. As a result, the front- and rear-edge position signals 412 and 413 are output from the decision circuit 1501 for each data cell.

Hereafter, the process flow will be described in detail by referring to FIGS. 14 and 15. In step 1600, the value of the counter that indicates the number of sampling points is set at zero. Next, in step 1601, the value of the counter is incremented by one. In step 1602, the output Q(V1) of the V1 comparator is monitored at the detection timing of the number indicated by the counter. In step 1603, it is determined, based on the output Q(V1) of the comparator, whether the readout signal has exceeded V1. If not, step 1601 is repeated until the readout signal exceeds V1. If the readout signal exceeds V1, the process goes to step 1604, where the value of the counter at the time when VI was exceeded is stored as M.

Then, in order to detect the sample value at the Mth detection timing, the outputs of the comparators with their individual levels are monitored. Initially, in step 1605, the initial value of the counter designating the number of the comparator is set at zero. Next, in step 1606, the value of the counter is updated one by one. In step 1607, the output of the comparator of the number indicated by the counter is acquired. In step 1608, it is determined whether or not the output of the comparator is one. If not, step 1606 is repeated and the number of the counter is increased until the output becomes one. In step 1609, the value of the counter producing the output of one is recorded in the counter as m. In step 1610, a relative front-edge position is searched for by using the value of m and a relative front-edge table. In step 1611, the combination of the relative front-edge position obtained in step 1610 and the value M obtained in step 1604 is converted into a front-edge position number, which is allocated in units of specific intervals A in the data cell. In step 1612, the front-edge position number is outputted as the front-edge position.

The process then goes to steps for detecting the rear-edge position. In step 1613, the value of the counter indicating the number of the sampling timing is updated by one. In step 1614, the output Q(Vnₘₐₓ) of the Vnₘₐₓ-value comparator is monitored at the detection timing of the number indicated by the value of the counter. In step 1615, it is determined, based on the output Q(Vnmax) of the comparator, whether or not the readout signal has exceeded Vnmax. If not, step 1613 is repeated until the readout signal exceeds Vnmax. If it does, the process goes to step 1616 to detect the timing at which the readout signal begins to fall from the saturation level. In step 1616, the value of the counter indicating the number of the sampling timing is updated by one. In step 1617, the output Q(Vnₘₐₓ) of the Vnₘₐₓ-value comparator is monitored at the detection timing of the number indicated by the value of the counter. In step 1618, it is determined, based on the output Q(Vnₘₐₓ) of the comparator, whether or not the readout signal has dropped below Vnmax. If not, step 1616 is repeated until the readout signal drops below Vnmax. When it does, the comparison of the sample values is stopped and the process goes to step 1619, where the value of the counter when the readout signal dropped below Vnₘₐₓ is stored as L.

Then, in order to detect the sample value at the Lth detection timing, the outputs of the comparators with their individual levels are monitored. Initially, in step 1620, the initial value of the counter designating the number of a comparator is set at nmax. Next, in step 1621, the value of the counter is decreased one by one. In step 1622, the output Q(Vn) of the comparator of the number indicated by the counter is acquired. In step 1623, it is determined whether or not the output of the comparator is zero. If not, step 1621 is repeated and the number of the counter is decreased until the output becomes zero. In step 1624, the value of the counter producing the output of zero is recorded in the counter as p. In step 1625, a relative rear-edge position is searched for by using the value of p and a relative rear-edge table. In step 1626, the combination of the relative rear-edge position obtained in step 1625 and the sampling timing L obtained in step 1619 is converted into a rear-edge position number, which is allocated in units of specific intervals A in the data cell. In step 1627, the rear-edge position number is outputted as the rear-edge position.

Referring to FIG. 4, an equalizer circuit may be inserted immediately after the pre-amplifier 404 in order to perform a signal processing on the waveform read from the disk. In this case, the minimum mark can be made shorter, so that the mutual interference from the front and rear edges can be decreased, and therefore the signal amplitude can be increased, even if the readout signal level from the mark decreases. Furthermore, because the waveform after equalization has reduced levels of interference from the front and rear edges, the waveform can be treated in the same way as is the readout signal that has been described in the previous embodiment of the invention. Thus, when the equalizing process is performed, the minimum mark length can be made shorter than that without such a process. This enables more information to be put in a data cell when the data cell length is fixed.

The following is a rough comparison between modulation code 17PP (1 to 7 Parity Preserved) used for a Blu-ray disk and the present invention in terms of the amount of disturbance in a recorded mark area that influences the disturbance in the amount of transmitted light in the case of a 4-layer Blu-ray disk and with a common physical minimum mark length with respect to a non-readout layer adjoining a readout layer. The diameter of a “defocused spot” on an adjacent layer of a readout layer in the 4-layer Blu-ray disk can be approximated using the following equation:

$$d \times \frac{NA}{\sqrt{{n}^{2} - {NA}^{2}}} \times 2$$

where d is the distance between recording layers, NA is the numerical aperture of a lens, and n is the refractive index of a film between recording layers.

If the channel bit interval is T in 17PP, the minimum mark length of 17PP is 2T. Since the minimum mark length is 6A in the code of the invention, it follows that A=T/3. Signal detection may become more difficult due to the narrower signal detection interval in the case of the invention, compared with 17PP channel bit interval. However, measures can be taken by, for example, employing super resolution recording/reading technology. The codeword length of the invention in this case is 18A=6T.

The distance between recording layers of a 2-layer Blu-ray disk is 25 pm. Since other two layers are added between the two recording layers in the case of a 4-layer Blu-ray disk, making the distance between the recording layers 1/3, the distance between the layers of the 4-layer Blu-ray disk is approximately 8.333 pm. A lens of NA=0.85 is used for the Blu-ray disk. Further, a film between recording layers has a refractive index n of approximately 1.57. Thus, the diameter of a spot on an adjacent layer can be roughly calculated to be about 10.7323 [m=10732.3 nm. Since the channel bit length is 74.5 nm when the storage capacity is 25 giga bytes per layer of the Blu-ray disk, the diameter of the spot on the adjacent layer corresponds to approximately 144 bit lengths (144T when represented in time). In the following comparison, the diameter of the spot on the adjacent layer, which is influenced by disturbance in the mark area, is assumed to be 144 bit lengths.

First, the amount of disturbance in the mark area is calculated in the case of 17PP by examining the minimum and maximum mark areas in a sequence having a spot diameter of 144 bit lengths. In the Blu-ray disk format, the disturbance in the mark area is reduced by performing or not performing inversion in units of 69-bit DC control block depending on the integrated value of DC.

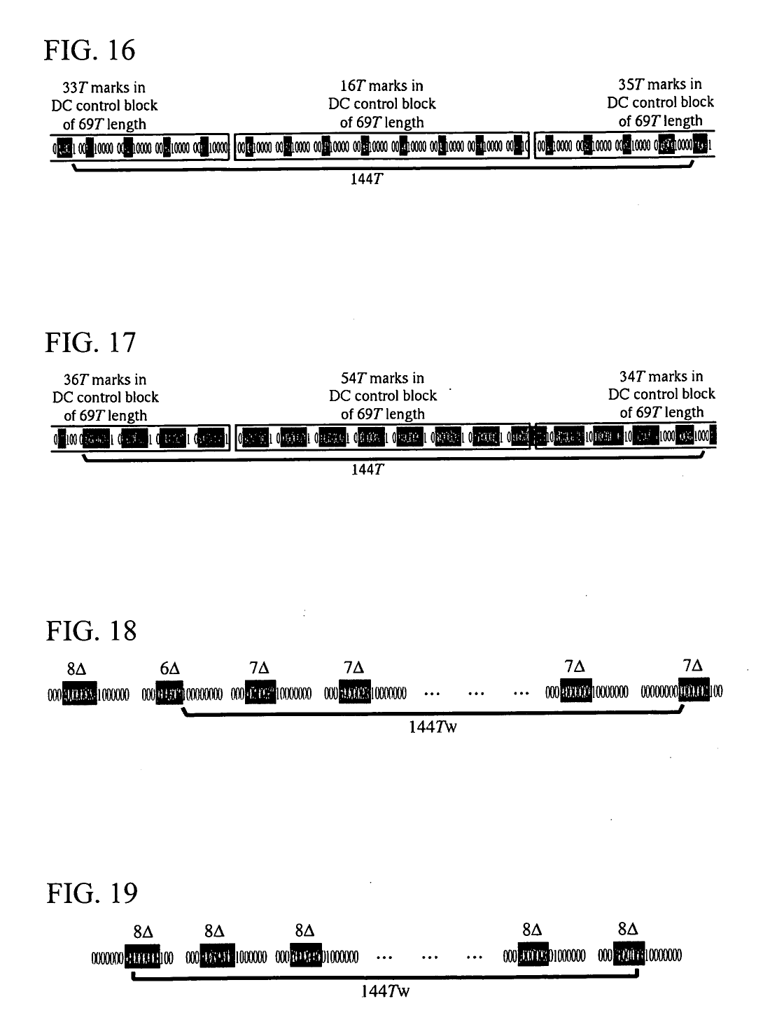

FIG. 16 shows a sequence having a length of 144 T and the minimum mark area. In this case, the total mark length and the total mark area can be approximated to be (2Tx4)+16T+(2Tx3+4T)=34T and 34Tw, respectively.

FIG. 17 shows a sequence having a length of 144 T and the maximum mark area. In this case, the total mark length and the total mark area can be approximated to be (7Tx4)+54T+(2T+7Tx3+5T)=IIOT and 1lOTw, respectively.

Thus, the ratio of the maximum to the minimum value of the area of the marks in the case of 17PP is derived to be approximately 3.235-(=. 110/34) According to the invention, it is possible to reduce the ratio of the maximum to the minimum value of the area of the marks. FIGS. 18 and 19 show an example of the result of a search for the minimum mark area and the maximum mark area in a sequence having a length of 144 T in Embodiments 1 and 2. In this case, the ratio of the maximum to the minimum value of the area of the marks is 196/162 -1.210.

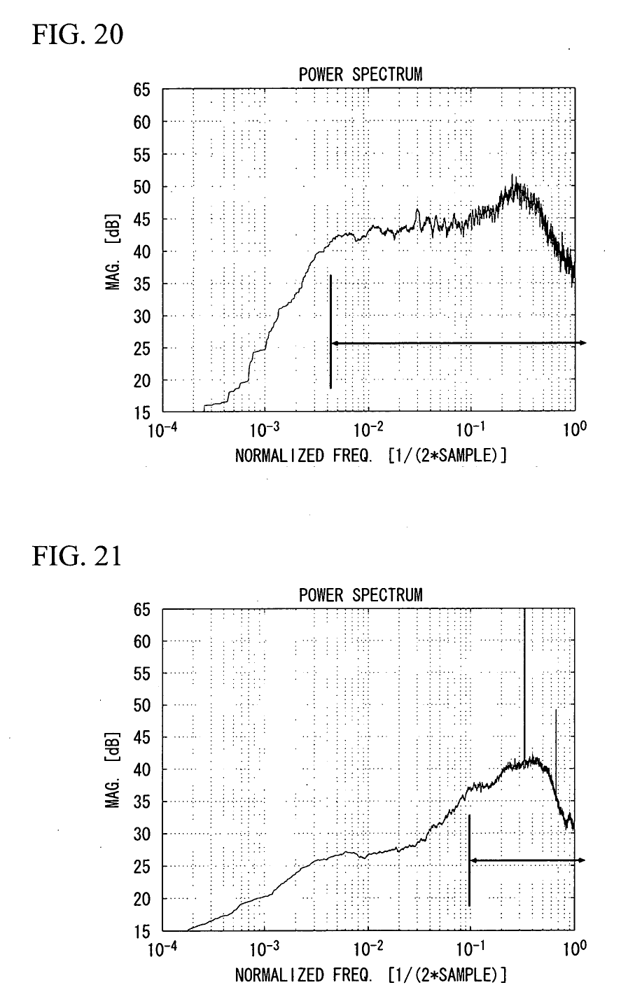

A power spectrum is compared in the following between 17PP and the invention. FIGS. 20 and 21 show a power spectrum of 17PP and the invention, respectively, in a case where the physical minimum mark lengths are aligned. The arrows in FIGS. 20 and 21 show a signal bandwidth. The signal bandwidth can be made narrower in the invention than in 17PP. Noise can be reduced by reducing signals in frequency bands other than the signal bandwidth with the use of a filter. Additionally, since signal components concentrate at higher frequencies, the invention is expected to be suitable for super resolution technology for reading smaller marks, than those of the conventional 17PP.

[Embodiment 2]

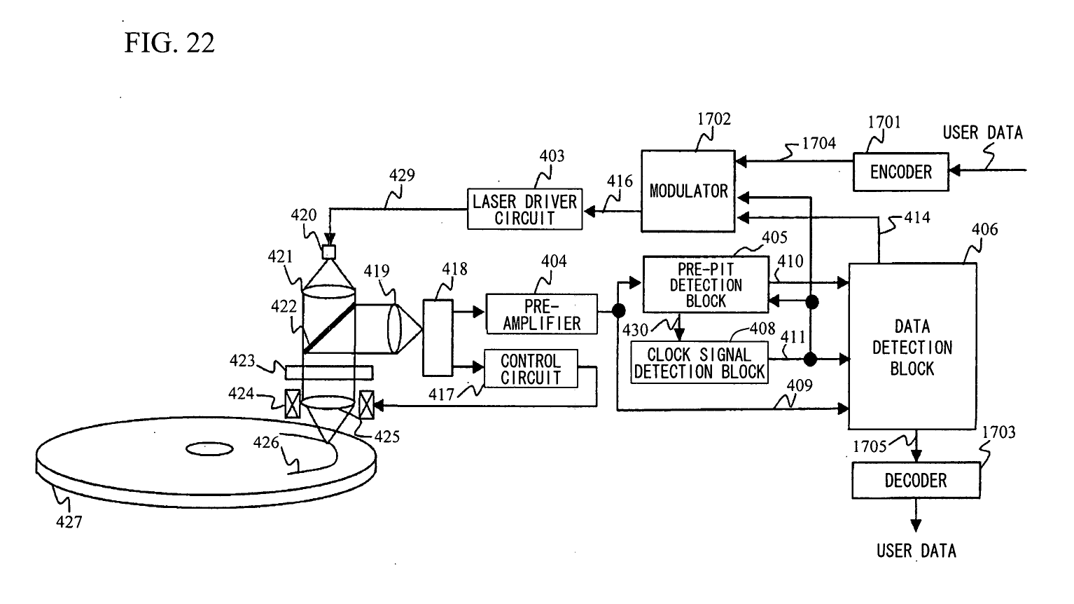

A second embodiment of the invention will be described with reference to FIGS. 22 to 24. FIG. 22 shows a block diagram of an optical information recording and reproducing apparatus according to the invention in a case where a data cell contains one or a plurality of marks. The apparatus differs from that of FIG. 4 only in the encoder, modulator, and decoder. While the encoder 401 outputs the front- and rear-edge positions, an encoder 1701 outputs an NRZI (Non Return to Zero Inverted) codeword 1704. In accordance with such modification, a modulator 1702 is modified to receive the NRZI codeword 1704 and output a signal 416, and a decoder 1703 is modified to receive a detected NRZI codeword 1705 and output user data. By having the encoder to output the NRZI codeword, the extension of the data cell structure for improving recording efficiency, such as adapting the data cell to contain a plurality of marks or having a mark to appear over the border between data cells, can be easily made. The “1” of the NRZI codeword corresponds to the front- and rear-edge positions of the mark in the data cell.

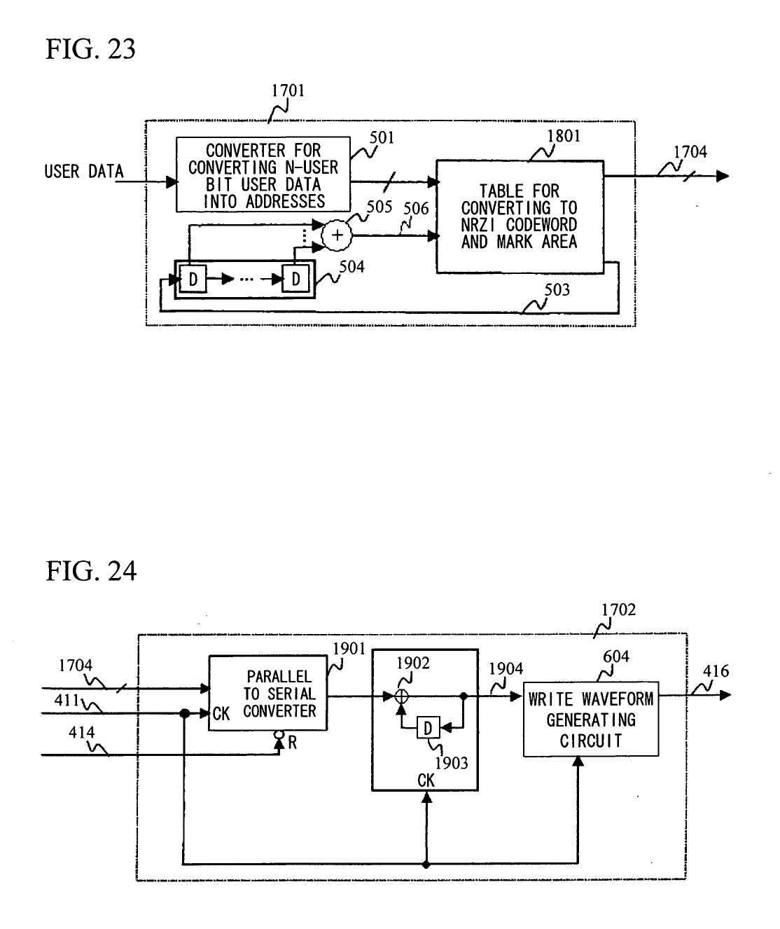

FIG. 23 shows a block diagram of an example of the encoder 1701. The output of each shift register in the shift register circuit 504, which stores mark areas for the past m data cells, is inputted to the m-input adder 505, and a sum 506 of the mark areas in m data cells is outputted. N-bit user data is converted by an address converter 501 into addresses for a converting table that will be described later. The addresses and the sum 506 of the mark areas are inputted to a circuit 1801 having t tables that convert the addresses and the sum 506 into the NRZI codeword and the total mark area in the data block. The table 1801 then outputs NRZI codeword data 1704 and total mark area data 503, of which the NRZI codeword data 1704 is used as the output of the encoder 1701. The total mark area data 503 is inputted to the shift register circuit 504, and each shift register value in the shift register circuit 504 is updated.

An example of the converting table 1801 corresponding to FIGS. 7 and 8 will be described by referring Tables 3 and 4 shown below. It is also assumed herein that the mark area is proportional to the mark length and that the mark area is obtained by multiplying the mark length by a proportional constant w. A data cell is divided into 18 regions at specific intervals A, and each region is given a number from I to 18, as shown in FIG. 7. An upper n-th bit of the codewords is represented as “0” when both or neither region numbers (n-I) and n are included in a mark in a data cell. A table is created by associating each user bit with the combination of the NRZI codeword that represents a data cell as described above and the mark area. Table 3 shows 16 items selected from data cells having marks with areas of 6Aw to 8Aw. Table 4 shows 16 items selected from data cells having marks with areas of 7Aw to 10Aw. The hatched portions of the NRZI codewords in Tables 3 and 4 represent bits corresponding to marks.

TABLE 3

| | Codeword | Mark | | Codeword | Mark |
|---|---|---|---|---|---|
| User bit | (NRZI) | area | User bit | (NRZI) | area |
| 0000 | 000010000010000000 | 6Δw | 1000 | 000000100000010000 | 7Δw |
| 0001 | 000001000001000000 | 6Δw | 1001 | 000000010000001000 | 7Δw |
| 0010 | 000000100000100000 | 6Δw | 1010 | 000000001000000100 | 7Δw |
| 0011 | 000000010000010000 | 6Δw | 1011 | 000100000001000000 | 8Δw |
| 0100 | 000000001000001000 | 6Δw | 1100 | 000010000000100000 | 8Δw |
| 0101 | 000100000010000000 | 7Δw | 1101 | 000001000000010000 | 8Δw |
| 0110 | 000010000001000000 | 7Δw | 1110 | 000000100000001000 | 8Δw |
| 0111 | 000001000000100000 | 7Δw | 1111 | 000000010000000100 | 8Δw |

TABLE 4

| | Codeword | Mark | | Codeword | Mark |
|---|---|---|---|---|---|
| User bit | (NRZI) | area | User bit | (NRZI) | area |
| 0000 | 000100000000100000 | 9Δw | 1000 | 000000100000010000 | 7Δw |
| 0001 | 000010000000010000 | 9Δw | 1001 | 000000010000001000 | 7Δw |
| 0010 | 000001000000001000 | 9Δw | 1010 | 000000001000000100 | 7Δw |
| 0011 | 000000100000000100 | 9Δw | 1011 | 000100000001000000 | 8Δw |
| 0100 | 000010000000001000 | 10Δw | 1100 | 000010000000100000 | 8Δw |
| 0101 | 000100000010000000 | 7Δw | 1101 | 000001000000010000 | 8Δw |
| 0110 | 000010000001000000 | 7Δw | 1110 | 000000100000001000 | 8Δw |
| 0111 | 000001000000100000 | 7Δw | 1111 | 000000010000000100 | 8Δw |

Use of the NRZI codewords in Tables 3 and 4 is another way of describing the data cells expressed by the front edge and the rear edge in Tables 1 and 2 in the first embodiment, respectively. By designating Table 3 as a table used when the total mark area in the past two data cells is 1 5Aw or more and by designating Table 4 as a table used when the total mark area in the past two data cells does not reach 15Aw, the minimum and maximum values of an average mark area per data cell in a data cell sequence can be 7Aw and 8Aw, respectively.

FIG. 24 shows the block diagram of an example of the modulator 1702. The NRZI codeword data 1704 is inputted to a parallel-serial converter 1901 at the intervals of the input of the prepit block detection signal 414. The parallel-serial converter 1901 outputs the bits in NRZI codewords in serial form at the intervals of the input of the clock signal 411. Then, a pulse signal 1904 is produced, via an exclusive-OR circuit 1902 and 1-bit data shift resistor 1903, which rises or falls at “1” in the NRZI codewords. The pulse signal is converted by a write waveform generating circuit 604 into a waveform 416 that is actually recorded.

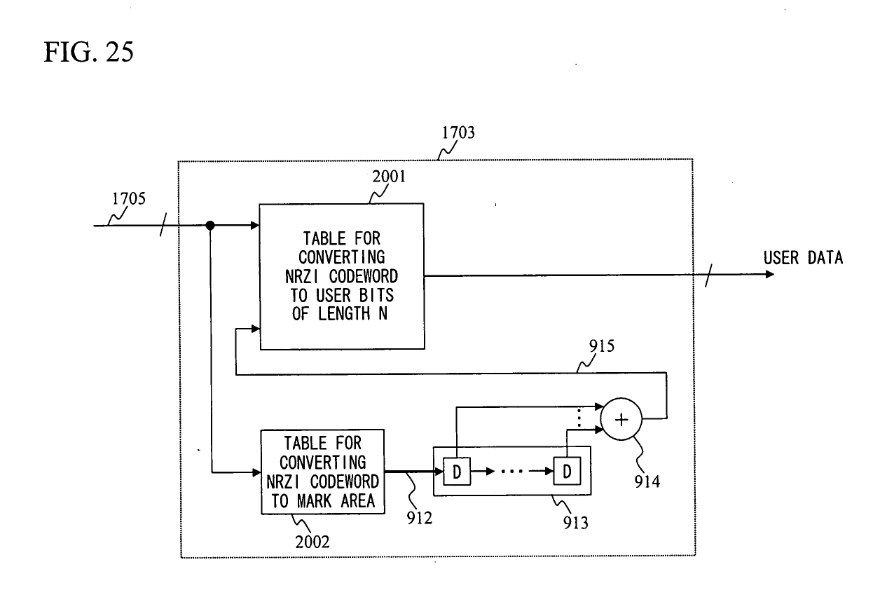

FIG. 25 shows the block diagram of an example of the decoder 1703. The output of each shift resistor contained in a shift resistor circuit 913 that stores mark lengths for the past m data cells is inputted to an m-input adder 914, which then outputs a sum 915 of mark areas in m data cells. The NRZI codeword 1705 and the sum 915 of mark areas are inputted to a table 2001 that converts the NRZI codeword into N user bits. The table 2001 outputs corresponding user data. While the table 2001 is similar to the foregoing Table 1, it performs inverse conversion with respect to the foregoing Tables 3 and 4. Generally, it associates user data with a combination of the NRZI codewords and the sum of mark areas in the m data cells. Since the user data corresponding to the mark area 7Aw and 8Aw that are commonly included in Tables 3 and 4 is the same, a table for decoding Tables 3 and 4 does not need to be switched with the sum of mark areas in the past m data cells. Meanwhile, a mark area converting circuit 2002 calculates the total mark area in the data cell indicated by the NRZI codeword 1705 and outputs a calculation result 912. The calculation result 912 is inputted to a shift resistor circuit 913, thereby updating each shift resistor value therein.

[Embodiment 3]

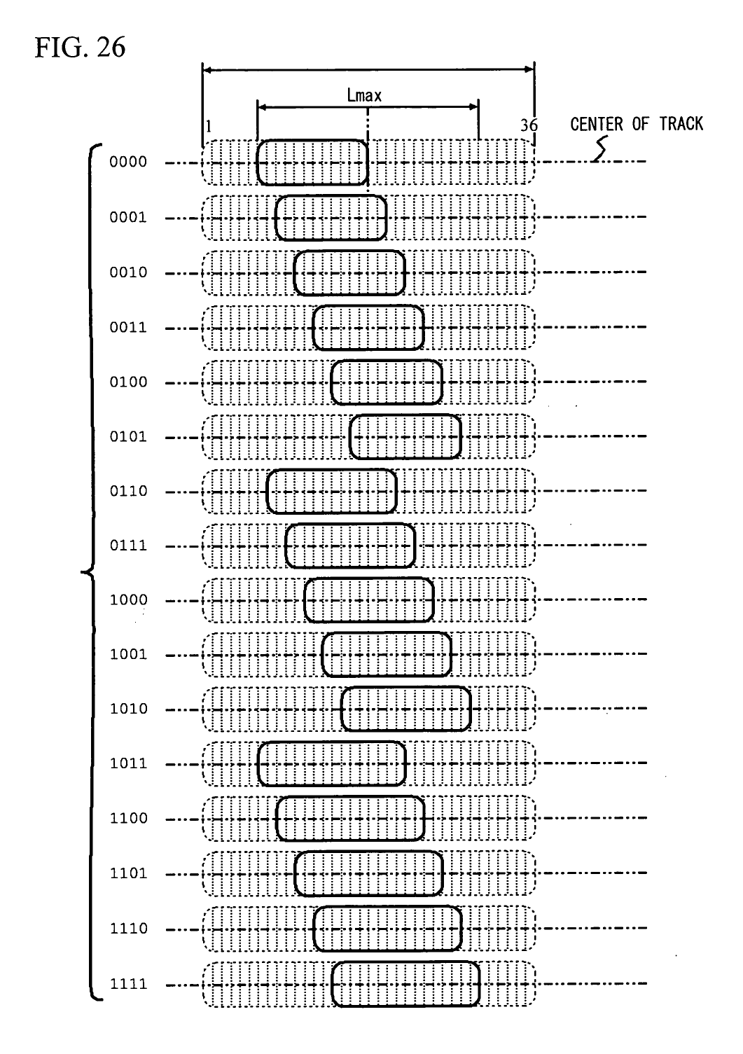

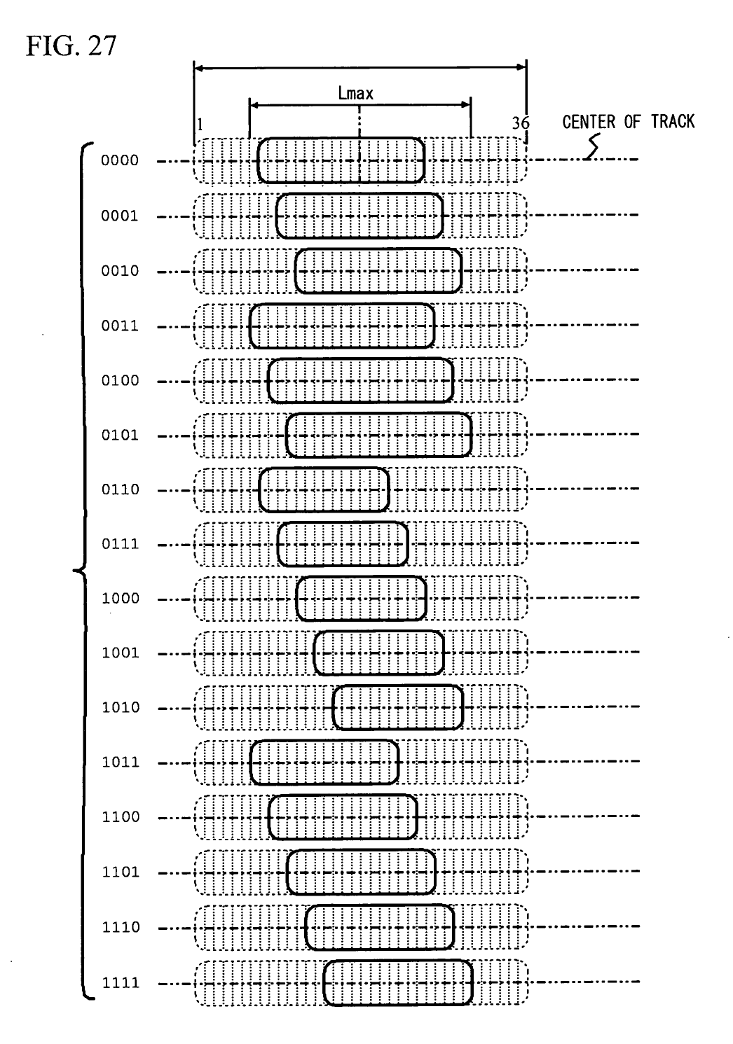

Referring to FIGS. 26, 27, 28, and 29, another method for detecting a mark length and a mark center position through a signal level and a differential zero cross point of a signal will be described. FIGS. 26 and 27, which are used in the present embodiment instead of FIGS. 7 and 8, show the correspondence between user data and data cells. In FIGS. 26 and 27, user data and data cells are associated by using a specific interval A that is one half the A in FIGS. 7 and 8 so that the number of data cell regions is doubled. For codewords having marks with lengths that are odd-number multiples of 2A′ , the mark position is shifted by A. A mark center detection interval is A/2=A′ when detecting a center position of a mark in each data cell in a data cell sequence converted from user data using FIGS. 7 and 8 (for example, the difference between a center position of a mark having a length 7A′ and a center position of a mark having a length 8A, both having the same front edge position). However, a mark center detection interval is 2A′ when detecting a center position of a mark in each data cell in a data cell sequence converted from user data using FIGS. 26 and 27 in which the width of A is half that of FIGS. 7 and 8 and the number of data cell regions is doubled.

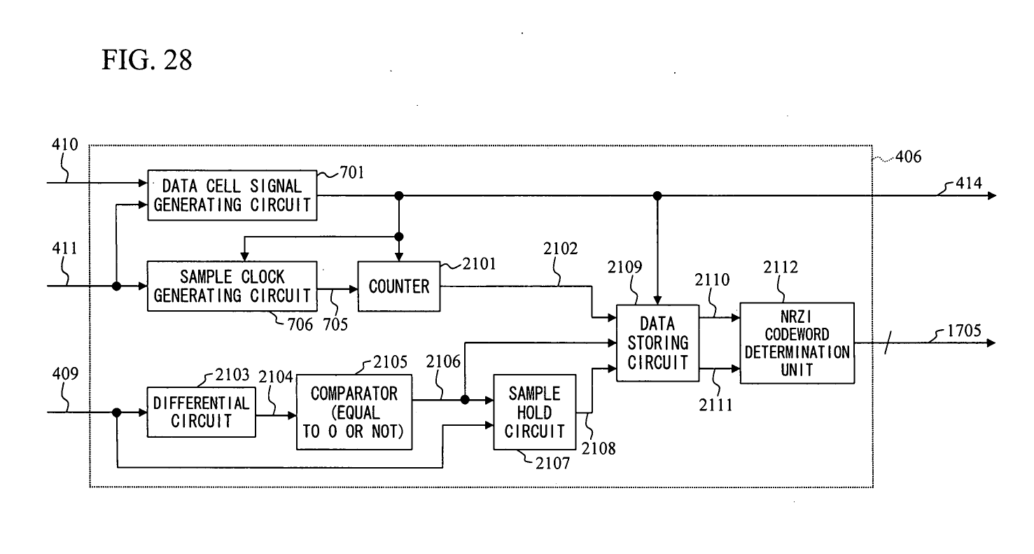

FIG. 28 shows a block diagram of an example of a data detector 406. The data cell signal 414, which indicates break points between data cells, is generated in a data cell signal generating circuit 701 based on the prepit signal 410, which indicates the period in which a group of prepits exists, and the clock signal 411. Based on the output 414, a counter 2101 is reset and a value stored in a data storing circuit 2109 is outputted. Further, based on the output 414 from the data cell signal generating circuit 701 and the clock signal 411, the sample clock 705 corresponding to the specific intervals A is created by the sample clock generating circuit 706. When the output 705 from the sample clock generating circuit 706 is inputted to the counter 2101, a counter value 2102 is outputted, thereby incrementing the value inside the counter by one. A readout signal 409 is inputted to a differential circuit 2103 and an output 2104 therefrom is inputted to a comparator 2105 that outputs a timing pulse 2106 indicating a zero crossing point at the time of the zero crossing point of the differentiated readout signal. Meanwhile, the readout signal 409 is inputted to a sample hold circuit 2107, and the level of the readout signal 409 is sample-held with the timing pulse 2106 outputted from the comparator 2105. The sample hold circuit 2107 outputs a sample-held level value 2108. The data storing circuit 2109 operates with the timing pulse 2106 and stores the counter value 2102 and the sample-held level value 2108. Upon the input of the output 414, the data storing circuit 2109 outputs a counter value 2110 and a sample-held level value 2111 that are inputted to an NRZI codeword determination unit 2112. The NRZI codeword determination unit 2112 outputs a determined NRZI codeword 1705.

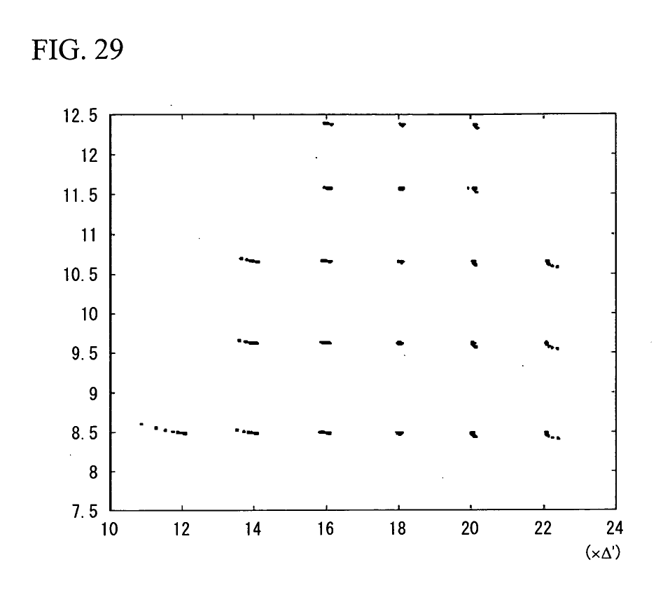

FIG. 29 show a diagram in which random user data is superposed on points of peak positions of readout signals corresponding to a data cell sequence generated by tables that correspond to FIGS. 26 and 27 and signal levels sample-held at such peak positions, using a simple simulation. The points are divided at intervals of the data cell width. Since the disturbance in edge position due to interference of a mark is not adjusted in the simulation, the peak positions are displaced from positions of 2A′ multiples. However, as can be seen in FIG. 29, it can be confirmed that the peak positions, namely, the center positions of the marks, are approximately 2A′. By adjusting the edge position, it becomes possible to surmise that, for example, a mark is a minimum mark having the center position at 12 A′ when the counter value is 11 or more and less than 13 and the sample-held signal level is 8.0 or more and less than 9.0. Thus, a data cell or its corresponding NRZI codeword can be surmised using thresholds.

[Embodiment 4]

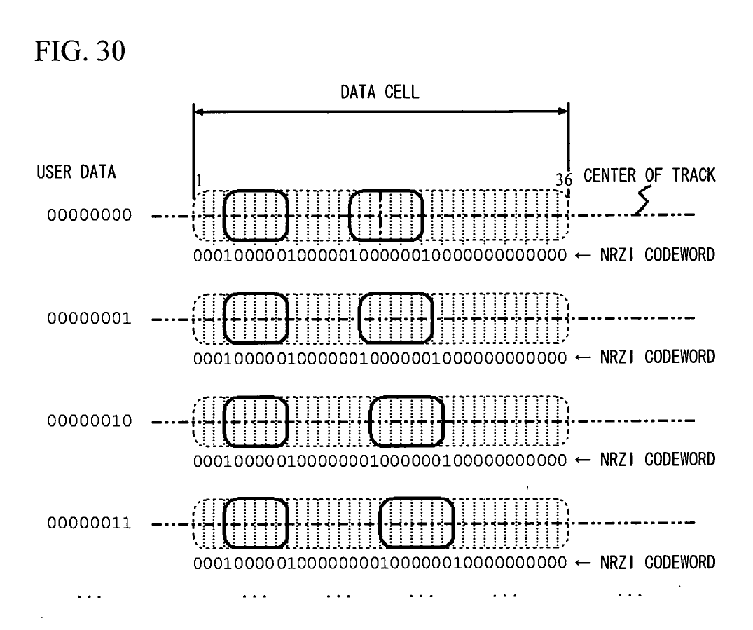

Referring to FIG. 30, a case where the converting table 1801 according to the third embodiment of the invention switches three tables and a data cell contains two marks will be described. The present embodiment is similar to the second embodiment except that the converting table 1801 switches three tables and the contents of the table 2001, which converts NRZI codewords in the decoder 1703 into N user bits, are changed in accordance with the converting table 1801. The data cell is divided into 36 regions at a specific interval A and each region is given a number from 1 to 36 as shown in FIG. 30. If a mark includes both or neither a region number (n-I) and a region number n in a data cell, an upper n-th bit of the NRZI codeword is indicated as “0” and as “1” otherwise. A table is created by associating each user bit with a combination of the NRZI codeword that represents data cells as above and the mark area. In this example, since each table includes 256 NRZI codewords, FIG. 30 only shows a part of the correspondence of the NRZI codewords and data cells in one of the tables to be switched.

Table 5 shows the total of mark areas and the number of possible data cells, in a case where two marks are present in a data cell and the area of one mark is between 6Aw and 9Aw. By selecting data cells with the following five conditions, three tables to be switched can be constituted. A first condition is that a first table should have all the 156 codewords that correspond to data cells having the total mark area value 13Aw and have 100 codewords that correspond to data cells having the total mark area value 14Aw. A second condition is that a second table should have 100 codewords that correspond to data cells having the total mark area 14Aw and 156 codewords that correspond to data cells having the total mark area 15Aw. A third condition is that a third table should have 156 codewords that correspond to data cells having the total mark area 1 5Aw and 100 codewords that correspond to data cells having the total mark area 1 6Aw. A fourth condition is that the correspondence between the codewords that correspond to data cells having the total mark area 14Aw and the user bits is identical between the first and second tables. A fifth condition is that the correspondence between the codewords that correspond to data cells having the total mark area 15Aw and the user bits is identical between the second and third tables.

TABLE 5

| Total mark area | Number of codewords |
|---|---|
| 12Δw | 91 |
| 13Δw | 156 |
| 14Δw | 198 |
| 15Δw | 220 |
| 16Δw | 135 |
| 17Δw | 72 |
| 18Δw | 28 |

The first to third tables as thus structured are switched such that the first table is used when the total mark area in the past four data cells is 57Aw or more, the second table is used when 55Aw or more and less than 57Aw, and the third table is used when less than 55Aw, for coding. In this way, the minimum value of the average mark area per data cell in a data cell sequence can be set to be 14Aw and the maximum value thereof can be set to be 1 4.2Aw. This corresponds to the acquisition of (m, T 1, T2)=(4, 55Aw, 57Aw) as a result of searching combinations of the number m (m <4) of the past data cells referred to and a pair of mark area thresholds (1I and 2T) for the minimum ratio of the maximum to the minimum values of the average of the mark areas in the data cell sequence.

What is claimed is:

1. An information recording apparatus for recording data by forming one or a plurality of marks in each of a plurality of data cells provided along a track on a recording medium, the apparatus comprising:
a light source;
optics for forming a small spot on the recording medium by converging light flux emitted from the light source;
an encoder for converting user data into mark information comprised of a combination of front- and rear-edge positions of a mark formed in the data cell, using a converting table;
a modulator for generating a write waveform based on the mark information outputted from the encoder; and
a light source driving unit for driving the light source in accordance with the write waveform outputted from the modulator, wherein the encoder includes a plurality of converting tables and switches the converting tables for use in accordance with the area of the marks contained in a predetermined number of most recent data cells.

2. The information recording apparatus according to claim 1, wherein the encoder comprises t converting tables and wherein the minimum value of the area of the marks in a data cell represented by a codeword in a j-th converting table is smaller than the minimum value of the area of the marks in a data cell represented by a codeword in a (0+l)-th table, where 1 <j-t-l.

3. The information recording apparatus according to claim 1, wherein the encoder comprises t converting tables and wherein the maximum value of the area of the marks in a data cell represented by a codeword in a j-th converting table is smaller than the maximum value of the area of the marks in a data cell represented by a codeword in a 0+1)-th table, where 1<j <t-l.

4. The information recording apparatus according to claim 2, wherein a first converting table is used when t<-S, the j-th converting table is used when Tj+i <S<-j and 1 <-j<t-1, and the t-th converting table is used when rT.>S for encoding, where T, to Tt-i are a number (t-1) of threshold values in decreasing order for switching the t converting tables, and S is the mark area in a predetermined number of past data cells.

5. The information recording apparatus according to claim 3, wherein a first converting table is used when Tt-<S, the j-th converting table is used when Tj+,-<S<Tj and 1 -<j<t-l, and the t-th converting table is used when Tt I>S for encoding, where Tj to Tt-I are a number (t-1) of threshold values in decreasing order for switching the t converting tables, and S is the mark area in a predetermined number of past data cells.

6. The information recording apparatus according to claim 4, wherein the (t-1) thresholds are such that the ratio of the maximum to the minimum area of the marks in a sequence that the data cell can possibly take is minimized.

7. The information recording apparatus according to claim 5, wherein the (t-1) thresholds are such that the ratio of the maximum to the minimum area of the marks in a sequence that the data cell can possibly take is minimized.

8. An information reproducing apparatus for reproducing information by detecting one or a plurality of marks in each of a plurality of data cells provided along a track on a recording medium, the apparatus comprising:
optics for irradiating the recording medium with an optical spot;
a photodetector for detecting light reflected by the recording medium;
a detecting unit for detecting mark information in the data cell by processing a readout signal outputted from the photodetector; and
a decoder for converting the mark information into user data with a converting table, wherein the converting table uniquely converts each item of mark information into user data independently of past mark information, wherein user data exists that is associated with both mark information regarding the minimum mark area and mark information regarding the maximum mark area.

9. The information reproducing apparatus according to claim 8, wherein the detecting unit detects a combination of front- and rear-edge positions of a mark in the data cell.

10. The information reproducing apparatus according to claim 8, wherein the detecting unit detects the center position and the length of the mark in the data cell.

11. An information recording method for recording data by forming one or a plurality of marks in each of a plurality of data cells provided along a track of a recording medium, the method comprising the steps of:
calculating the total area of the marks in a predetermined number of most recent data cells;
selecting one of a plurality of converting tables based on the calculated total area of the marks;
converting user data into mark information comprised of a combination of front- and rear-edge positions of the mark formed in the data cell, using the selected converting table;
generating a write waveform based on the mark information; and
driving a light source in accordance with the write waveform and recording a mark on the recording medium.

12. The information recording method according to claim 11, comprising the use of t converting tables, wherein the minimum value of the area of the marks in.a data cell represented by a codeword in a j-th converting table is smaller than the minimum value of the area of the marks in a data cell represented by a codeword in a (+1) table, where

13. The information recording method according to claim 11, comprising the use of t converting tables, wherein the maximum value of the area of the marks in a data cell represented by a codeword in a j-th converting table is smaller than the maximum value of the area of the marks in a data cell represented by a codeword in a (+1) table, where 1-<j-<t- 1.

14. The information recording method according to claim 12, wherein a first converting table is used when T -<S the j-th converting table is used when Tj+l- S<Tj and I <-j<t-l, and the t-th converting table is used when TI>S for encoding, where Tj to T. I are a number (t-1) of threshold values in decreasing order, and S is the mark area in a predetermined number of past data cells.

15. The information recording method according to claim 13, wherein a first converting table is used when Tt <S. the j-th converting table is used when Tj+1 <S<Tj and 1I <j<t-l, and the t-th converting table is used when TI>S for encoding, where T, to Ti are a number (t-1) of threshold values in decreasing order, and S is the mark area in a predetermined number of past data cells.
